(19) United States
(12) Patent Application Publication
(10) Pub. No.: US 2024/0086423 A1
(43) Pub. Date: Mar. 14, 2024

(54) HIERARCHICAL GRAPH CLUSTERING TO ENSEMBLE, DENOISE, AND SAMPLE FROM SELEX DATASETS

(71) Applicant: X Development LLC, Mountain View, CA (US)

(72) Inventors: Lance Co Ting Keh, La Crescenta, CA (US); Ivan Grubisic, Oakland, CA (US); Ryan Poplin, Newark, CA (US); Jon Deaton, Mountain View, CA (US); Hayley Weir, Mountain View, CA (US)

(73) Assignee: X Development LLC, Mountain View, CA (US)

(21) Appl. No.: 17/898,236

(22) Filed: Aug. 29, 2022

(51) Int. Cl. G06F 16/28; G06N 3/0455; G06N 3/08

(52) U.S. Cl. CPC G06F 16/285; G06N 3/0455; G06N 3/08

(57) ABSTRACT

Some techniques relate to projecting aptamer representations into an embedding space and clustering the representations. A cluster-specific binding metric can be defined for each cluster based on aptamer-specific binding metrics of aptamers associated with the cluster. A subset of the clusters can be selected based on the cluster-specific binding metrics. Identifications of aptamers assigned to the subset of clusters can then be output.

### SEQUENCE LISTING

The instant application contains a Sequence Listing which has been filed electronically in .XML format and is hereby incorporated by reference in its entirety. Said .XML copy, created on Nov. 2, 2022, is named 1327711 ST26.txt and is 9,725 bytes in size.

### BACKGROUND

Aptamers are short sequences of single-stranded oligonucleotides (e.g., anything that is characterized as a nucleic acid, including xenobases). The sugar backbone of the single-stranded oligonucleotides functions as the acid and the A (adenine), T (thymine), C (cytosine), G (guanine) refers to the base. An aptamer can involve modifications to either the acid or the base. Aptamers have been shown to selectively bind to specific targets (e.g., proteins, protein complexes, peptides, carbohydrates, inorganic molecules, organic molecules such as metabolites, cells, etc.) with high binding affinity. Further, aptamers can be highly specific, in that a given aptamer may exhibit high binding affinity for one target but low binding affinity for many other targets. Thus, aptamers can be used to (for example) bind to disease-signature targets to facilitate a diagnostic process, bind to a treatment target to effectively deliver a treatment (e.g., a therapeutic or a cytotoxic agent linked to the aptamer), bind to target molecules within a mixture to facilitate purification, bind to a target to neutralize its biological effects, etc. However, the utility of an aptamer hinges on a degree to which it effectively binds to a target.

Frequently, an iterative experimental process (e.g., Systematic Evolution of Ligands by EXponential Enrichment (SELEX)) is used to identify aptamers that are selectively bound to target molecules with high affinity. In the iterative experimental process, a nucleic acid library of oligonucleotide strands (aptamers) is incubated with a target molecule. Then, the target-bound oligonucleotide strands are separated from the unbound strands and amplified via polymerase chain reaction (PCR) to seed a new pool of oligonucleotide strands. This selection process is continued for a number (e.g., 6-15) rounds with increasingly stringent conditions, which ensure that the oligonucleotide strands obtained have the highest affinity to the target molecule.

The nucleic acid library typically includes 10¹⁴-10¹⁵ random oligonucleotide strands (aptamers). However, there are approximately a septillion (10²⁴) different aptamers that could be considered. Exploring this full space of candidate aptamers is impractical. However, given that present-day experiments are now only a sliver of the full space, it is highly likely that optimal aptamer selection is not currently being achieved. This is particularly true when it is important to assess the degree to which aptamers bind with multiple different targets, as only a small portion of aptamers will have the desired combination of binding affinities across the targets. Accordingly, while substantive studies on aptamers have progressed since the introduction of the SELEX process, it would take an enormous amount of resources and time to experimentally evaluate a septillion (10²⁴) different aptamers every time a new target is proposed. In particular, there is a need for improving upon current experimental limitations with scalable machine-learning modeling techniques to identify aptamers and derivatives thereof that selectively bind to target molecules with high affinity.

### SUMMARY

In some embodiments a computer-implementer method is provided that includes identifying a binding target of interest; identifying—for each aptamer of a plurality of aptamers—a sequence for the aptamer; generating—for each aptamer of a plurality of aptamers and using each of a set of machine-learning models and using the sequence—a projection for the aptamer; generating—for each aptamer of a plurality of aptamers—an aggregate representation for the aptamer based on the projections; performing a clustering-based process using the aggregate representations of the set of aptamers so as to generate a set of clusters, wherein at least two of the set of aptamers are assigned to each cluster of the set of clusters; identifying—for each cluster of the set of clusters and for each aptamer assigned to the cluster—an aptamer-specific binding metric corresponding to the aptamer and a specific target; determining—for each cluster of the set of clusters—a cluster-specific binding metric based on the aptamer-specific binding metrics corresponding to the aptamers assigned to the cluster and to specific target; selecting a subset of the set of clusters based on the cluster-specific binding metrics, where the subset is smaller than the set of clusters; and outputting an identification of aptamers corresponding to the selected subset of the at least two of the set of clusters.

The method may include, for each cluster of the at least two of the set of clusters: identifying a binding-metric difference condition; detecting one or more aptamers for which the bind-metric difference condition is satisfied; and modifying, for each of the one or more aptamers, the aptamer-specific binding metric, wherein the output identifies the one or more aptamers.

The method may include: calculating, for each cluster of the set of clusters, a skew, precision, standard deviation, or variance of the aptamer-specific binding metrics for aptamers assigned to the cluster, wherein the subset of the set of clusters are selected based on the skews, precisions, standard deviations, or variances.

Performing the clustering-based process can include performing an initial clustering and performing a subsequent iterative merging of various clusters.

The set of machine-learning models may include a language model.

The set of machine-learning models may include a variational autoencoder or a modified version thereof.

The set of machine-learning models may include a deep neural network.

Performing the clustering-may include, for each aptamer of the set of aptamers: projecting the aggregate representation for the aptamer along each of one or more defined axes; and computing, for each other aptamer of one or more other aptamers in the set of aptamers, a dot product between the projection of the aggregate representation and a projection of the other aptamer.

Performing the clustering-may include: performing a sketching process to produce a set of candidate pairs, wherein each of the set of candidate pairs includes aggregate representations of two aptamers, and wherein the set of candidate pairs is a subset of a total pair-wise combinations of aggregate representations of the set of aptamers; and calculating, for each candidate pair of the set of candidate pairs, a similarity measure between the aggregate representations of the two aptamers in the candidate pair.

In some embodiments, a computer-implementer method is provided that includes: identifying a binding target of interest; identifying, for each aptamer of a plurality of aptamers, a sequence for the aptamer; generating, for each aptamer of a plurality of aptamers and using each of a set of machine-learning models and using the sequence, a projection for the aptamer; generating, for each aptamer of a plurality of aptamers, an aggregate representation for the aptamer based on the projections; performing a clustering-based process using the aggregate representations of the set of aptamers so as to generate a set of clusters, where at least two of the set of aptamers are assigned to each cluster of the set of clusters; identifying, for each cluster of the set of clusters and for each aptamer assigned to the cluster, an aptamer-specific binding metric corresponding to the aptamer and a specific target; determining, for each cluster of the set of clusters and for a cluster-specific binding metric based on the aptamer-specific binding metrics corresponding to the aptamers assigned to the cluster and to specific target; selecting a subset of the set of clusters based on the cluster-specific binding metrics, where the subset is smaller than the set of clusters; and outputting an identification of aptamers corresponding to the selected subset of the at least two of the set of clusters.

The method may further include, for each cluster of the at least two of the set of clusters: identifying a binding-metric difference condition; detecting one or more aptamers for which the bind-metric difference condition is satisfied; and modifying, for each of the one or more aptamers, the aptamer-specific binding metric, where the output identifies the one or more aptamers.

The method may include calculating, for each cluster of the set of clusters, a skew, precision, standard deviation, or variance of the aptamer-specific binding metrics for aptamers assigned to the cluster, where the subset of the set of clusters are selected based on the skews, precisions, standard deviations, or variances.

Performing the clustering-based process may include performing an initial clustering and performing a subsequent iterative merging of various clusters.

The set of machine-learning models may include a language model.

The set of machine-learning models may include a variational autoencoder or a modified version thereof.

The set of machine-learning models may include a deep neural network.

Performing the clustering-may include, for each aptamer of the set of aptamers: projecting the aggregate representation for the aptamer along each of one or more defined axes; and computing, for each other aptamer of one or more other aptamers in the set of aptamers, a dot product between the projection of the aggregate representation and a projection of the other aptamer.

Performing the clustering-may include: performing a sketching process to produce a set of candidate pairs, where each of the set of candidate pairs includes aggregate representations of two aptamers, and where the set of candidate pairs is a subset of a total pair-wise combinations of aggregate representations of the set of aptamers; and calculating, for each candidate pair of the set of candidate pairs, a similarity measure between the aggregate representations of the two aptamers in the candidate pair.

In some instances, a method is provided that includes: accessing a multi-dimensional latent space that corresponds to projections of sequences of aptamers, where the multi-dimensional latent space was defined by an Encoder network having been defined by parameters learned by training a machine-learning model that included the Encoder network, a Decoder network configured to transform data points in the multi-dimensional space into sequence representations of a type processed by the Encoder network, and a Classifier network configured to transform data points in the multi-dimensional space a predicted label corresponding to a prediction relating to—with respect to a particular target—whether binding will occur, a binding affinity, a probability of binding to a particular modality, whether inhibition will occur, or an inhibition strength; generating a set of projections in the multi-dimensional latent space using representations of a plurality of aptamers and the Encoder network; identifying one or more candidate aptamers for the particular target using the set of projections and using the Decoder network, where the one or more candidate aptamers are a subset of the plurality of aptamers; and outputting an identification of the one or more candidate aptamers.

Identifying the one or more candidate aptamers may include: identifying one or more starting positions within the multi-dimensional latent space; and traversing the multi-dimensional latent space from the one or more starting positions by iteratively generating particular predicted labels using the Classifier network and moving across the multi-dimensional latent space, where a direction and/or magnitude of the movement depends on the particular predicted labels.

Identifying the one or more candidate aptamers may include: identifying a plurality of starting positions within the multi-dimensional latent space; and performing an interpolation or fitting technique using the plurality of starting positions to predict predicted labels at positions between the plurality of starting positions using the Classifier network.

Identifying the one or more candidate aptamers may include: performing a clustering technique using the set of projections to identify a set of clusters; determining, for each of the set of clusters, a statistic for the cluster using the labels for at least some of the aptamers corresponding to the cluster; and identifying one or more clusters of the set of clusters based on the determined statistics.

Identifying the one or more candidate aptamers may include: identifying a set of aptamers, from the plurality of aptamers, that are associated with a label of enhanced quality relative to labels of other aptamers in the plurality of aptamers; fitting a support vector machine in the multi-dimensional latent space using the projections of representations of the set of aptamers and the labels of the set of aptamers; identifying a decision boundary based on the fitting of the support vector machine; and traversing the latent space in a direction normal to the decision boundary.

Identifying the one or more candidate aptamers may include: identifying one or more starting positions within the multi-dimensional latent space, where each of the one or more starting positions is associated with a label of enhanced quality relative to labels of at least some other aptamers in the plurality of aptamers; and identifying one or more nearest neighbors to the one or more starting positions.

The machine-learning model may have been trained using (Systematic Evolution of Ligands by EXponential Enrichment) SELEX data.

In some embodiments, a system is provided that includes one or more data processors and a non-transitory computer readable storage medium containing instructions which, when executed on the one or more data processors, cause the one or more data processors to perform part or all of one or more methods disclosed herein.

In some embodiments, a computer-program product is provided that is tangibly embodied in a non-transitory machine-readable storage medium and that includes instructions configured to cause one or more data processors to perform part or all of one or more methods disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification and variation of the concepts herein disclosed may be resorted to by those skilled in the art, and that such modifications and variations are considered to be within the scope of this invention as defined by the appended claims.

### BRIEF DESCRIPTION OF THE DRAWINGS

The present disclosure is described in conjunction with the appended figures:

FIG. 1A illustrates an exemplary process for using one or more machine-learning models to generate projections of aptamers to use for selecting aptamers for further utility and/or investigation.

FIG. 1B illustrates an example of how base pairs and binding-affinity labels change throughout an illustrative gradient-ascent traversal of a multi-dimensional space.

FIGS. 2A and 2B show exemplary representations of a linear interpolation and a spherical linear representation, respectively.

FIG. 3 shows a block diagram of a pipeline for strategically identifying and generating high affinity binders of molecular targets.

FIGS. 4A-4C illustrate—in relation to one-hot embeddings—the influence of various parameters on various embedding-related characteristics.

FIGS. 5A-5C illustrate—in relation to Transformer Encoder embeddings—the influence of various parameters on various embedding-related characteristics.

FIGS. 6A-6C illustrate—in relation to Sequence-Aware Variational Autoencoder (SAVAE) embeddings—the influence of various parameters on various embedding-related characteristics.

FIG. 7A shows an example of how the cumulative distribution function (CDF) of cluster sizes changes as the iteration of the clustering proceeds.

FIG. 7B shows an example of how the CDF of the inter-cluster edge weights (top plots) and of the intra-cluster edge weights (bottom plots) changes as the iteration of the clustering proceeds.

FIGS. 8A and 8B show the distribution of flow through normalized (FTn) across aptamer-pair representations for two targets, with the left plots in each of FIGS. 8A and 8B corresponding to the inter-cluster data, and the right plots corresponding to intra-cluster data.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides preferred exemplary embodiments only, and is not intended to limit the scope, applicability or configuration of the disclosure. Rather, the ensuing description of the preferred exemplary embodiments will provide those skilled in the art with an enabling description for implementing various embodiments. It is understood that various changes may be made in the function and arrangement of elements without departing from the spirit and scope as set forth in the appended claims.

Specific details are given in the following description to provide a thorough understanding of the embodiments. However, it will be understood that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart or diagram may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

### Select Terminology

As used herein, the term “aptamer” refers to a an oligonucleotide or peptide molecule. An aptamer scan be a single-stranded DNA or RNA (ssDNA or ssRNA) molecule. An aptamer may include (for example) less than 100, less than 80 or less than 60 nucleotides. Typically, a region of about 10-15 nucleotides of the aptamer is what binds to a target molecule. Thus, predicting that an aptamer will bind to a given target may include predicting that a particular portion of the aptamer will bind to a given target. Similarly, if it is predicted that a particular set of nucleotides (e.g., between 10-15 nucleotides) will bind to a given target, it may be predicted that a full aptamer that includes the particular set of nucleotide will bind to the given target. It will be appreciated that some disclosures herein may refer to generating a prediction or performing an assessment that pertains to one or more “aptamers”, though such disclosures may—more precisely—relate to prediction or performing an assessment that pertains to a binding region of an aptamer. (One or more full aptamers that includes the binding region may subsequently be identified and/or tested.)

As used herein, the term “binding affinity” refers to the free energy differences between native binding and unbound states, which measures the stability of native binding states (e.g., a measure of the strength of attraction between an aptamer and a target). As used herein, a “high binding affinity” is a result from stronger intermolecular forces between an aptamer and a target leading to a longer residence time at the binding site (higher “on” rate, lower “off” rate). The factors that lead to high affinity binding include a good fit between surface of the molecules in their ground state and charge complementary (i.e., stronger intermolecular forces between the aptamer and the target). These same factors generally also provide a high binding specificity for the targets, which can be used to simplify screening approaches aimed at developing strong therapeutic candidates that can bind the given molecular target. As used herein, the term “binding specificity” means the affinity of binding to one target relative to the other targets. As used herein, the term “high binding specificity” means the affinity of binding to one target is stronger relative to the other targets. Various aspects described herein design and validate aptamers as strong therapeutic candidates that can bind the given molecular target based on binding affinity. However, it should be understood that design and validation of aptamers could involve the assessment of binding affinity and/or binding specificity. Binding affinity can be measured or reported by the equilibrium dissociation constant (K_{D}), which is used to evaluate and rank order strengths of bimolecular interactions. The smaller the K_{D} value, the greater the binding affinity of the aptamer for its target. The larger the K_{D} value, the more weakly the target molecule and the aptamer are attracted to and bind to one another. In other words binding affinity and dissociation factor can have an inverse correlation. The strength of binding between an aptamer and its target can be also expressed by measuring or reporting a binding avidity between the aptamer and the target. While the term affinity characterizes an interaction between one aptamer domain with its binding site (assessed by corresponding dissociation constant K_{D}), the avidity refers to the overall strength of multiple binding interactions and can be described by the K_{D} of an aptamer-target complex.

### Overview

Identification of high affinity and high specificity binders (e.g., monoclonal antibodies, nucleic acid aptamers, and the like) of molecular targets (e.g., VEGF, HER2) has dramatically transformed treatment of many types of diseases (e.g., oncology, infectious disease, immune/inflammation, etc.). However, given the large search space of potential sequences (e.g., 10²⁴ or 4⁴⁰ potential sequences for the average aptamer or monoclonal antibody CDR-H3 binding loop) and the comparatively low-throughput of methodologies to assess the binding affinity of candidates (e.g., dozens to thousands per week), it is highly likely that optimal binder selection is not currently being achieved. While selection based approaches (e.g., phage display, SELEX, and the like) can potentially identify binders, among libraries of millions to trillions of candidates, there are several weaknesses with these approaches: (i) output is binary—it is challenging to know whether relatively strong binders in the library are actually strong binders; (ii) data is noisy—binding is dependent on every candidate encountering available target with the same relative frequency and variance from this can lead to many false negatives and some false positives; and (iii) capacity is much smaller than the total search space—phage display (max candidates ˜10⁹) and SELEX (max candidates ˜10¹⁴) search spaces much smaller than the total possible search space (additionally, it is generally difficult (or expensive) to characterize the portions of the total sequence space that are searched). Thus, two major challenges to identifying aptamers of interest is that the quantity of aptamers in a search space is very large, the signal-to-noise of initial labels is typically very low, and yet—to improve the signal-to-noise, it can be important that diverse sequences are used for intermediate “experimental flywheel” testing so as to improve the signal to noise across multiple portions of the search space.

To address these challenges, efforts have been made to apply computational and machine-learning techniques in an “experiment in the loop” process to reduce the search space and design better binders. For example, the following computational and machine-learning techniques have been attempted to increase discovery of viable high affinity/high specificity binders of molecular targets: (i) identification of libraries more likely to bind via prediction from physics based models, (ii) input of selection data and design/identify more likely binders (for monoclonal antibodies and nucleic acid aptamers), and (iii) address other factors beyond affinity that affect commercialization and therapeutic potential. To date however, these computational and machine-learning techniques have had limited success in designing markedly different sequences with better properties, let alone with sufficient predictive power to align on a small set of sequences appropriate for low-throughput characterization. Particularly, the techniques in the second category, often struggle to input sufficient data to identify or design candidates that are markedly different from the training sequences used to train the computation and machine-learning models.

To address these limitations and others, techniques and systems are disclosed herein to efficiently identify select aptamers to experimentally test to determine a binding affinity with a particular target. The percentages of the select aptamers that bind to the particular target may be higher (when the selection is based on prioritizing target binding) as compared to a corresponding of a comparative subset of aptamers selected based only on SELEX labels (given the high noise in SELEX labels). Alternatively, when aptamer selection is based on prioritizing no target binding, the percentage of the select aptamers that bind to the particular target may be lower as compared to a corresponding of a comparative subset of aptamers selected based only on SELEX labels.

More specifically, the techniques and systems may include implementations of processes (e.g., graph-based processes) that use machine-learning models to generate a projection for each of many aptamers, a clustering technique to cluster the aptamer projections, and a filtering technique to select one or more select clusters for which aptamers in the cluster(s) are identified for potential experimental investigation of binding.

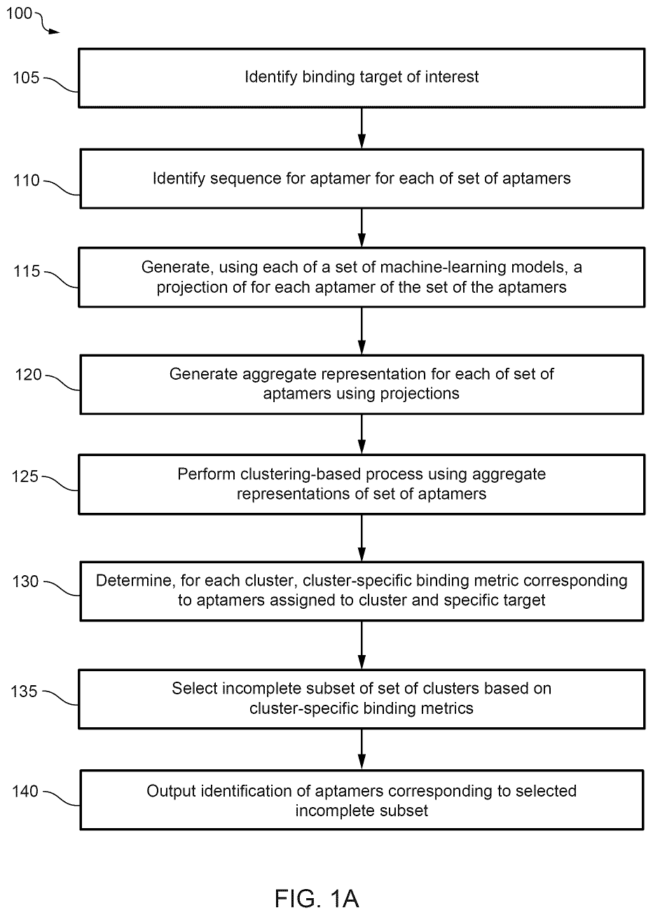

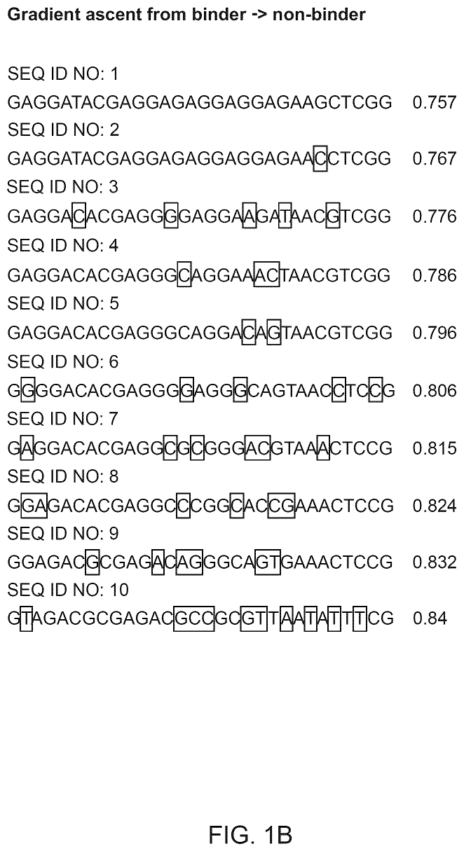

FIG. 1A illustrates an exemplary process 100 for using one or more machine-learning models to generate projections of aptamers to use for selecting aptamers for further utility and/or investigation. At block 105, a binding target of interest is identified. The binding target may be (for example) a particular virus, bacteria, type of cell, cell with a given sequence signature, cell with an epigenetic signature, etc.

At block 110, a sequence for each aptamer in a set of aptamers is identified. The set of aptamers may include (for example) each and every aptamer represented in a given library, each and every aptamer represented in a given library and complying with a given condition (e.g., sequence length and/or user-specified attribute), a representative sample from a library, etc. The library may include a SELEX library. In some instances, the set of aptamers include a first plurality of aptamers, each aptamer of the first plurality is associated with SELEX data indicating whether the aptamer is predicted to bind with a particular target and a second plurality of aptamers for which there is not SELEX data available (e.g., to a given user or developer) in relation to the particular target.

At block 115, for each of the set of aptamers, a projection for the aptamer can be generated using each machine-learning model of one or more machine-learning models. The one or more machine-learning models may have been trained using a same data set using an objective function that prioritizes distinguishing aptamers that bind to a particular target from aptamers that do not bind to the particular target. The same data set may include SELEX data that pertains to the particular target. For example, each of the one or more machine-learning models may have been trained to generate projections that are informative as to whether the SELEX indicates that the corresponding aptamers bind to a particular target.

The one or more machine-learning models can include (for example) one or more of: a variational autoencoder model (or modified version thereof), a natural language processing model, a deep neural network, and/or a transformer model. (In some instances, a dimensionality of the projection is reduced using a sketching process, such as a Simhash sketching process or Tokenhash sketching process. Using a sketching process may improve computational efficiency of subsequent computations that rely on the projections, so as to reduce—for example—a quantity of pair-wise computations by an exponential amount. In some instances, sketching includes transforming a projection or an aggregate projection via a further projection to further reduce its dimensionality, and the transformed projection may then be used for clustering by, for example, performing distance-based calculations in the transformed space.)

In some instances, the one or more machine-learning model were trained as part of a Supervised Adversarial Variational Autoencoder, which may include Encoder, Decoder and Classifier networks. Each of one or more of the Encoder network, Decoder network, and Classifier network may include a neural network, such as a convolutional neural network, a Transformer, or a residual convolutional network. The Decoder network may be an auto-regressive Generator network that generates sequences incrementally through multiple passes.

The Encoder network may be configured to transform a representation of a sequence into a compact representation. The compact representation may be in a reduced space (e.g., that is configured to represent fewer and/or less complex variables) relative to the original space of the sequence. The reduced space may—but need not—have a reduced dimensionality relative to the original space. The Decoder network may be configured to transform a compact representation of the sequence in the reduced space into a full representation. The Decoder network may be trained as an auto-regressive generator that generates a sequence incrementally through multiple passes. The Classifier network may be configured to predict a functional attribute that may pertain to a particular target. For example, the Classifier network may be configured to predict a binding affinity that corresponds to a particular target. In some instances, the Classifier network is trained with data that is noisy, such as SELEX data. Despite the noise, labels used for the classification (e.g., that identify a binding probability, a binding probability or

The Supervised Adversarial Variational Autoencoder may be configured to use one or more loss functions that prioritize accurate decoding (and thus also efficient and also accurate encoding) and also accurate classification.

The machine-learning model may have been trained using data with relatively noisy labels. For example, the labels used during training may have been trained using SELEX labels that are noisy (e.g., with regard to binding affinity).

At block 120, an aggregate representation of the aptamer (e.g., a projection in and of itself) can be generated based on the projections corresponding to multiple machine-learning models. The aggregate representation may be generated by (for example) concatenating the projections and potentially performing a dimensionality reduction. The dimensionality reduction can be performed using a sketching process, such as one using a Simhash sketching process or Tokenhash sketching process.

At block 125, the clustering technique can then be used to cluster the aggregate representations. The clustering technique may include an iterative technique, where—during intermediate iterations—various clusters are merged together.

The library may identify, for each of multiple aptamers (e.g., for each aptamer in the first plurality of aptamers), an aptamer-specific binding metric that corresponds to the aptamer and a specific binding target. The aptamer-specific binding metric may include a binary number (e.g., where a “1” indicates that the aptamer binds to the specific binding target and where a “0” indicates that the aptamer does not bind to the specific binding target) or a real number (e.g., a binding affinity of an aptamer for the specific binding target).

At block 130, a cluster-specific binding metric can be generated for each cluster based on the aptamer-specific binding metrics of aptamers assigned to the cluster. For example, a cluster-specific binding metric may include a percentage of the aptamers assigned to the cluster that have an aptamer-specific metric of 1 or that have an aptamer-specific metric that exceeds a predefined threshold. As another example, a cluster-specific binding metric may include an average, median, standard deviation, or variance of the aptamer-specific metrics of aptamers assigned to the cluster.

At block 135, a subset of the set of clusters can be selected based on the cluster-specific binding metrics, where the subset is smaller than the set. For example, the subset may include a predefined number of clusters having the highest (or alternatively the lowest) cluster-specific binding metrics. In some instances, a number of clusters in the subset is based on how many aptamers are assigned to the clusters (e.g., such that the subset still includes the clusters having the highest cluster-specific binding metrics, but the subset is to include the smallest number of clusters that still results in a cumulative total count of aptamers assigned to the subset as being greater than an aptamer-count threshold). The subset of clusters may be identified based on relatively noisy binding metrics, such as SELEX labels. For example, the subset of clusters may be identified by generating—for each cluster—a metric based on SELEX labels of the data points assigned to the cluster.

At block 140, an identification of each aptamer assigned to a cluster in the subset can be output. For example, the identifications can be transmitted to a client device via a message controlling a presentation of a webpage or interface, the identifications can be included in a file that is availed or transmitted for presentation or download, or the identifications can be transmitted as an instruction file to a device configured to initiate a process to (for example) experimentally measure the binding affinity of each of one or more (or all) aptamers in the selected subset(s) and the particular binding target and/or experimentally measure whether each of one or more (or all) aptamers in the selected subset(s) binds to the particular binding target. In some instances, receipt of the instruction file from a device corresponding to a laboratory system may automatically trigger experiments to measure whether each aptamer in the subset binds to the particular binding target, to measure a binding affinity between each aptamer in the subset and the particular binding target, etc.

The experiment results may be used to (for example) update the library with more accurate labels or to facilitate a selection of one or more aptamers in the subset for further testing and/or further use. For example, the one or more aptamers may be defined as a predetermined quantity of aptamers from the clusters with a highest binding affinity for the particular binding target. The one or more aptamers may be used for further in vitro experimentation, for in vivo experimentation, and/or for clinical study. For example, a clinical study may track the extent to which each of the one or more aptamers effectively treats a given disease and/or results in undesirable side effects (e.g., via in vivo studies, mammalian studies, or human studies).

It will be appreciated that various modifications of process 100 are considered. For example, instead of projecting representations of multiple aptamers, a projection of a single aptamer may be generated. Additionally or alternatively, a multi-dimensional space (e.g., generated by an Encoder network trained as part of a Supervised Adversarial Variational Autoencoder) may be traversed to identify one or more aptamers of interest. The traversal may be based on predicted functional characteristics (e.g., as predicted by using a Classifier network of the Supervised Adversarial Variational Autoencoder).

The traversal may be based on one or more select starting points of interest. The select point(s) of interest may have a quality that is higher than the labels used to train the Classifier network. For example, each of the select starting points may include a label that was generated by elution data that corresponds to a binding affinity that exceeds a predefined threshold. As another example, each of the select starting points may include a label that was generated by elution data that indicates inhibition for a given target occurred with at least a threshold degree.

In some instances, a random traversal is used to traverse the multi-dimensional space from the select starting point(s). The gradient ascent traversal may be configured to maximize labels generated by the Classification network that may include (for example): binding affinity, a probability of exhibiting at least a predefined threshold binding affinity, or a probability of binding to a particular modality of a target module. A gradient ascent traversal may use a technique as set forth in Table 1:

TABLE 1

```
Algorithm 1 Latent Space Hill-Climb Traversal
sequences ← { } [symbol]      Set of modified sequences.
z ← Encode(s, θ) [symbol]      Latent starting point.
d ← 0 [symbol]    Distance from original sequence.
while d < dₘₐₓ do
$z ← z + α \frac{\partial \text{?} ( z )}{\partial z} ⊳ Gradient ascent$
  s′ ← Decode(z, θ) [symbol]    Modified sequence.
  d ← EditDistance(s, s′)
  sequences ← sequences ∪ {s′}
return sequences
```

$\text{?} \text{indicates text missing or illegible when filed}$

It will be appreciated that traversing the multi-dimensional space may corresponding to moving throughout the space in a manner that amounts to iteratively changing various bases. For example, FIG. 1B represents an illustrative example of how base pairs and binding-affinity labels change throughout an illustrative gradient-ascent traversal of a multi-dimensional space.

It will be appreciated that a gradient-descent traversal may be used to traverse the multi-dimensional space instead of or in addition to using a gradient-ascent traversal. For example, a gradient-descent traversal may be useful if labels used by a classifier correspond to a heterogeneity of binding targets, an unspecificity of binding targets, etc.

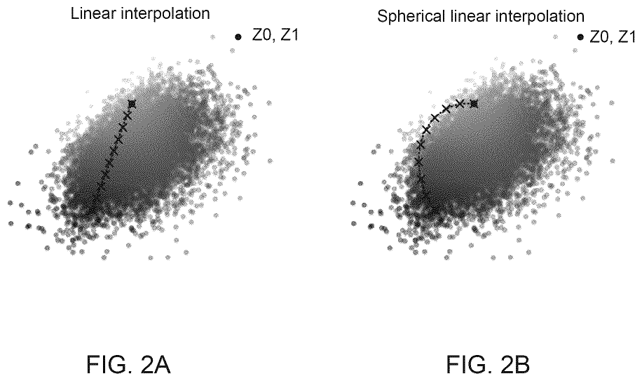

Another technique for traversing the multi-dimensional space is to use interpolation (e.g., linear and/or spherical interpolation) using the select data points (e.g., associated with labels that are less noisy than had been used to generate the multi-dimensional space). For example, a first select data point may be identified as one that corresponds to a low label (e.g., representing a predicted low binding affinity), and a second select data point may be identified as one that corresponds to a high label (e.g., representing a predicted high binding affinity). The first data point may correspond to a local or absolute extremum (e.g., maximum or minimum) of a label. The second data point may correspond to a local or absolute opposite extremum (e.g., minimum or maximum) of a label. A latent representation for the interpolation can be generated based on labels z at multiple coordinates (e.g., s₀ and s₁) to identify a potential point of interest (z_{α}). For example, a point of interest may be generated based on a correlation between and a variable of interest (e.g., binding affinity, functional inhibition, binding probability, etc.) or by using an interpolation technique (e.g., a spherical interpolation technique and/or a technique as disclosed by White, T. “Sampling Generative Networks”, available at https://arxiv.org/abs/1609.04468 (2016). FIGS. 2A and 2B show an exemplary representations of a linear interpolation and a spherical linear representation, respectively.

Yet another technique is to use a support vector machine and labels generated by the Classification network to generate a decision boundary. The boundary can then be used to segregate representations corresponding to one type of prediction (e.g., high binding affinity) relative to another type of prediction (e.g., low binding affinity).

### Pipeline for Identifying and Experimentally Assessing Candidate Aptamers

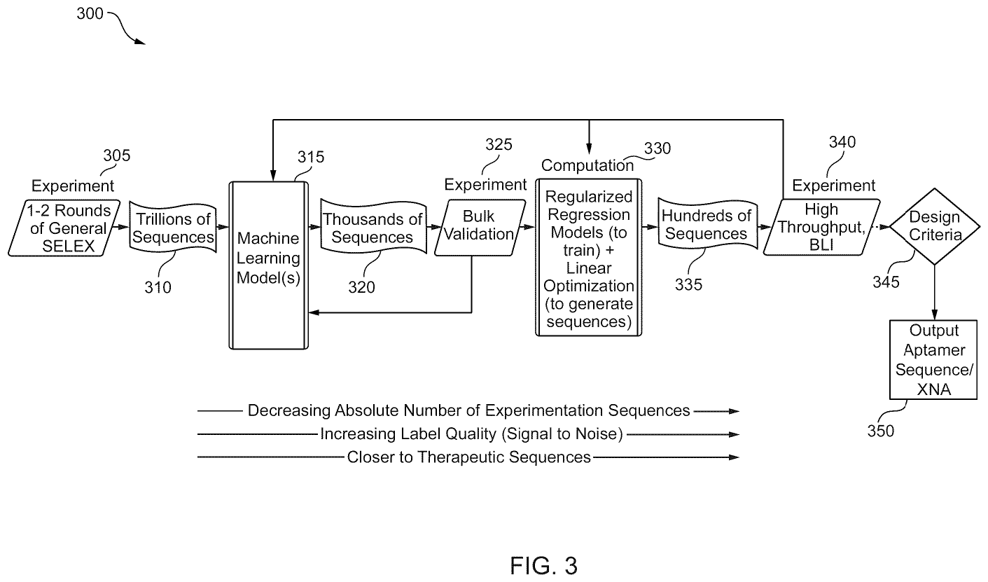

FIG. 3 shows a block diagram of a pipeline 300 for strategically identifying and generating high affinity binders of molecular targets. Pipeline 300 can include performing part or all of process 100 from FIG. 1A and/or performing one or more actions described herein. In various embodiments, the pipeline 300 implements in vitro experiments and in silico computation and machine-learning based techniques to iteratively improve a process for identifying binders (e.g., aptamers and/or binding regions) that can bind any given molecular target.

At block 305, in vitro binding selections (e.g., phages display or SELEX) are performed where a given molecular target (e.g., a protein of interest) is exposed to tens of trillions of different potential binders (e.g., a library of 10¹⁴-10¹⁵ nucleic acid aptamers), a separation protocol is used to remove non-binding aptamers (e.g., flow-through), and the binding aptamers are eluted from the given target. The binding aptamers and/or the non-binding aptamers are sequenced to identify which aptamers do and/or do not bind the given target. This binding selection process may be repeated for any number of cycles (e.g., 1 to 3 cycles) to reduce the absolute count of potential aptamers from tens of trillions of different potential aptamers down to millions or trillions of sequences 310 of aptamers identified to have some level of binding (specific and non-specific) for the given target.

In some instances, at least some of the millions or trillions of sequences 310 are labeled with one or more sequence properties. The one or more sequence properties may include a binding-approximation metric that indicates whether an aptamer included in or associated with the training data bound to a particular target. The binding-approximation metric can include (for example) a binary value or a categorical value. The binding-approximation metric can indicate whether the aptamer bound to the particular target in an environment where the aptamer and other aptamers (e.g., other potential aptamers) are concurrently introduced to the particular target. The binding-approximation metric can be determined using a high-throughput assay, such as in vitro binding selections (e.g., phages display or SELEX), a low-throughput assay, such as in vitro Bio-Layer Interferometry (BLI), or a combination thereof. Additionally or alternatively, the one or more sequence properties may include a function-approximation metric that indicates whether an aptamer included in or associated with the training data functions as intended (e.g., inhibits function A). The functional-approximation metric can include (for example) a binary value or a categorical value. The function-approximation metric can be determined using a low-throughput assay, such as an optical fluorescence assay or any other assay capable of detecting functional changes in a biological system (e.g., inhibiting an enzyme, inhibiting protein production, promoting binding between molecules, promoting transcription, etc.). Further, the function-approximation metric may be used to infer the binding-approximation metric (e.g., if function A is inhibited it can be inferred that the molecule bound to the particular target).

The sequences of binding aptamers, non-binding aptamers, or a combination thereof obtained from block 305 may have a low signal to noise ratio (and low label quality). In other words, the sequences in 310 may include a small amount of sequences of aptamers with specific binding or high affinity (signal) and a large amount of aptamer sequences with non-specific binding or low affinity binding to the given target (noise).

In some instances, at block 315, at least some of the sequences of binding aptamers, non-binding aptamers, or a combination thereof obtained from block 305 are used to train one or more machine-learning models (e.g., where each of at least one of the one or more machine-learning models is a highly parameterized machine algorithm with a parameter count of greater than or equal to 10,000, 30,000, 50,000, or 75,000) and learn a fitness function capable of filtering, sorting, ranking, or otherwise evaluating the fitness (quality) of sequences of aptamers based on one or more constraints such as a design criteria proposed for an aptamer, a problem being solved (e.g., finding an aptamer that is capable of binding to target with a high-affinity), and/or an answer to a query (e.g., which aptamers are capable of inhibiting function A). In some instances, multiple machine-learning models are trained to generate parallel and/or serial outputs. For example, machine-learning models with different architectures, with different hyperparameters, having been trained using different loss functions, having been trained using different training-data subsets may be trained to generate outputs. For example, each model of one or more the machine-learning models can include a model used to generate a projection at block 115 of process 100.

In some instances, outputs from multiple machine-learning models are combined so as to generate an aggregate output. Generating an aggregate output may include (for example) combing multiple interim outputs into an aggregate output of higher dimension, calculating a statistic based on multiple interim outputs (e.g., an average, median, mode, or range), or identifying an output produced by operations performed by a sequential operation of multiple machine-learning models. Thus, part or all of the data generated at block 305 can be used to train a model for processing outputs from multiple machine-learning models (e.g., where a model aggregates outputs from multiple models, clusters aggregate outputs from models, filters outputs based on multiple models, etc.).

At block 315, the sequences and their labels are fed to (e.g., the trained) one or more machine-learning models. As further described herein, the one or more machine-learning models may include one or more models to generate projections of the sequences (e.g., based on an Encoder trained as part of a Supervised Adversarial Variation Encoder and/or based on noisy labels), which may then be aggregated and fed to a clustering model to cluster the aggregate projections of the sequences. As further described herein, the clustering model (or a post-processing algorithm) further can select a subset of the clusters based on (for example) statistics of the clusters (e.g., to identify clusters associated with a high percentage of labels predicting binding).

It will be appreciated that, in some instances, only some of the sequences assessed by the clustering model may have a label. The labels of the some may be used to (for example) train the one or more models to generate sequence projections, and the trained models may then be used to generate projections for the sequences with labels and other sequences without labels.

A quantity of sequences represented in the subset of clusters may be a small fraction (e.g., less than 1/100, less than 1/1000, less than 1/10000, or less than 1/100000) of those represented across clusters. For example, a quantity of sequences represented in the subset of clusters may be thousands of sequences 320.

In some instances, rather than or in addition to identifying sequences by using a clustering technique, sequences are identified by traversing a multi-dimensional space. The traversal may use (for example) a gradient ascent technique, a gradient descent technique, an interpolation technique, a support vector technique, etc.

At block 325, identified sequences of aptamers 320 in the subset of clusters may be used to synthesize aptamers, which are used for subsequent binding selections. For example, subsequent in vitro binding selections (e.g., phages display or SELEX) may be performed where the given molecular target is exposed to the synthesized aptamers. A separation protocol may be used to remove non-binding aptamers (e.g., flow-through). The binding aptamers may then be eluted from the given target. The binding and/or non-binding aptamers may be sequenced to identify the sequence of aptamers that do and/or those that do not bind the given target. This binding selection process may be repeated for any number of cycles (e.g., 1 to 3 cycles) to validate which of the identified/designed aptamers from block 115 actually bind the given target. In some instances, the subsequent binding selections are performed using aptamers carrying Unique Molecular Identifiers (UMI) to enable accurate counting of copies of a given candidate sequence in elution or flow-through. Because the sequence diversity is reduced at this stage, there can be more copies of each aptamer to interact with the given target and improve the signal to noise ratio (and label quality).

The processes in blocks 305-325 may be performed once or repeated in part or in their entirety any number of times to decrease the absolute number of sequences and increase the signal to noise ratio, which ultimately results in a set of aptamer candidates that satisfy the one or more constraints (e.g., bind targets of interest in a inhibitory/activating fashion or to deliver a drug/therapeutic to a target such as a T-Cell). As used herein, “satisfy” the one or more constraints can be complete satisfaction (e.g., bound to the target), substantial satisfaction (e.g., bound to the target with an affinity above/below a given threshold or greater than 98% percent inhibition of a function A), or partial satisfaction (e.g., bound to the target at least 60% of the time or greater than 60% percent inhibition of a function A). The satisfaction of the constraint may be measured using one or more binding and/or analytical assays as described in detail herein.

The output from block 325 (e.g., bulk validation) may include aptamers that can bind to the target with varying strengths (e.g., high, medium or low affinities). The output from block 325 may also include aptamers that are not be capable of binding to the target. In some instances, the sequences of binding aptamers, non-binding aptamers, or a combination thereof obtained from block 325 are used to improve the machine-learning models in block 325 (e.g., by retraining or fine-tuning the machine-learning models that generate projections). The sequences of binding aptamers, non-binding aptamers, or a combination thereof from block 325 may be labeled with one or more sequence properties. The one or more sequence properties may include a binding metric that indicates whether an aptamer included in or associated with the training data bound to a particular target and/or a functional metric that indicates whether an aptamer included in or associated with the training data functions as intended (e.g., inhibits function A). In certain instances, the binding metric is determined from the subsequent in vitro binding selections (e.g., phages display or SELEX) performed in block 325 and/or a low-throughput assay, such as in vitro BLI.

At block 330, the sequences of binding aptamers, non-binding aptamers, or a combination thereof (optionally labeled with one or more sequence properties) obtained from block 325 are used to train an algorithm to identify sequences of aptamers 335 that can satisfy the one or more constraints (e.g., bind a given target). The algorithm may identify hundreds of additional or alternative sequences. The algorithm may include linear algorithms (for example) a support vector algorithm/machine or a regression algorithm (e.g., a linear regression algorithm). In some instances, the algorithm is a multiple regression algorithm. The regression algorithm may be trained using regularization techniques (i.e., fitting a model with more than one independent variable (covariates or predictors or features—all the same thing) to obtain a multiple regularized regression model. While the linear algorithms are less expressive than highly parametrized algorithms, the improved signal to noise at this stage can allow the linear algorithms to still capture signal while being better at generalizing.

Optimization techniques such as linear optimization may be used at this stage to identify the hundreds of additional or alternative sequences of aptamers 335 with differing relative fitness scores (and therefore affinity). Linear optimization (also called linear programming) is a computational method to achieve the best outcome (such as highest binding affinity for a given target) in a model whose requirements are represented by linear relationships (e.g., a regression model). More specifically, the linear optimization improves the linear objective function, subject to linear equality and linear inequality constraints to output the hundreds of additional or alternative sequences of aptamers 335 with differing relative fitness scores (including those with a highest binding affinity). Unlike the machine-learning model and searching process used in block 315, there may be greater confidence in deviating away from training data in the process of linear optimization due to better generalization by the regression models. Consequently, the linear optimization may not be constrained to a limited number of nucleotide edits away from the training dataset.

At block 340, identified or designed aptamer sequences 335 may be used to synthesize new aptamers. These new aptamers may then be characterized or validated using experiments 340. The experiments may include high throughput binding selections (e.g., SELEX) or low-throughput assays. In some instances, the low-throughput assay (e.g., BLI) is used to validate or measure a binding strength (e.g., affinity, avidity, or dissociation constant) of an aptamer to the given target. In this context, BLI may include preparing a biosensor tip to include the aptamers in an immobilized form and a solution with the given target in a tip of a biosensor. Binding between the molecule(s) and the particular target increases a thickness of the tip of the biosensor. The biosensor is illuminated using white light, and an interference pattern is detected. The interference pattern and temporal changes to the interference pattern (relative to a time at which the molecules and particular target are introduced to each other) are analyzed to predict binding-related characteristics, such as binding affinity, binding specificity, a rate of association, and a rate of dissociation. In other instances, the low-throughput assay (e.g., a spectrophotometer to measure protein concentration) is used to validate or measure functional aspects of the aptamer such as its ability to inhibit a biological function (e.g., protein production).

The processes in blocks 305-340 may be performed once or repeated in part or in their entirety any number of times to decrease the absolute number of sequences and increase the signal to noise ratio, which ultimately results in a set of aptamer candidates that best satisfy the one or more constraints (e.g., bind targets of interest in a inhibitory/activating fashion or to deliver a drug/therapeutic to a target such as a T-Cell). The output from block 140 (e.g., BLI) may include aptamers that can bind to the target with varying strengths (e.g., high, medium or low affinities). The output from block 340 may also include aptamers that are not be capable of binding to the target. In some instances, the sequences of binding aptamers, non-binding aptamers, or a combination thereof obtained from block 340 are used to improve the machine-learning models in block 315 and/or 330 (e.g., by retraining the machine-learning algorithms). The sequences of binding aptamers, non-binding aptamers, or a combination thereof from block 340 may be labeled with one or more sequence properties. As described herein, the one or more sequence properties may include a binding metric that indicates or predicts whether an aptamer included in or associated with the training data bound to a particular target and/or a functional metric that indicates or predicts whether an aptamer included in or associated with the training data functions as intended (e.g., inhibits function A). In certain instances, the binding-approximation metric is determined from the subsequent in vitro BLI performed in block 340.

In block 345, a determination is made as to whether one or more of the aptamers evaluated in block 340 satisfy the one or more constraints such as the design criteria proposed for an aptamer, the problem being solved (e.g., finding an aptamer that is capable of binding to target with a high-affinity), and/or the answer to a query (e.g., what aptamers are capable of inhibiting function A). The determination may be made based on the binding-approximation metric and/or the functional-approximation metric associated with an aptamer satisfying the one or more constraints. In some instances, an aptamer design criteria may be used to select one or more aptamers to be output as the final solution to the given problem. For example, the design criteria in block 345 may include a binding strength (e.g., a cutoff value), a minimum affinity or avidity between the aptamer and the target, or a maximum dissociation constant.

In block 350, one or more aptamers from experiments 340 that are determined to satisfy the one or more constraints (e.g., showing affinity greater or equal to the minimum cutoff) are provided, for example, as the final solution to the given problem or as a result to a given query. The providing the output may include generating an output library comprising the final set of aptamers. The output library may be generated incrementally as new aptamers are generated and selected by performing and/or repeating blocks 305-345. At each repetition cycle one or more aptamers may be identified (i.e., designed, generated and/or selected) and added to the output based on their ability to satisfy the one or more constraints. The providing the output may further include transmitting the one or more aptamers or output library to a user (e.g., transmitting electronically via wired or wireless communication).

It will be appreciated that although FIG. 3 and the description herein, describe going from trillions of sequences to thousands of sequences to hundreds of sequences, these numbers are merely provided for illustrative purposes. In general, it should be understood that pipeline 300 is provisioned to start with a large data set (a large absolute number of experimentation sequences which could be, for example, septillions, trillions, billions, or millions) for training a highly-parametrized algorithm and eventually narrows down the absolute number of experimentation sequences to a more manageable number eventually aligning on a small data set (a small absolute number of experimentation sequences which could be, for example, hundreds, tens, or less) for low-throughput characterization and validation as potential therapeutic candidates.

It will further be appreciated that process 300 need not be completed in its entirety. For example, some or all of blocks 325-345 may omitted from process 300. To illustrate, the machine-learning model(s) may be used to identify candidate aptamers to experimentally investigate for a given aim (e.g., binding to a given target), and identification of the candidate aptamers may be transmitted to a client (who may then experimentally test some or all of the candidate aptamers).

### EXAMPLE

Sequences for 35 million aptamers were identified. For each of these aptamers, SELEX data was used as label data to indicate whether the aptamer bound to a particular target. Notably, SELEX data is noisy, so some of the labels are erroneous.

For each of the 35 million aptamers, four projections of the aptamer were generated using four machine-learning models. Specifically, the four projections were one-hot embeddings, token features, Sequence-Aware Variational Autoencoder (SAVAE) embeddings, and Transformer Encoder (specifically, Bidirectional Encoder Representations from Transformers (BERT) embedding) final encoder output embeddings. A single parameter (numparameters) was defined to identify the dimensionality of each of the four projections.

An aggregate projection was defined using the four projections. Determining the aggregate projection included setting a sketching process, a number of projections per vector, a sketch size, and/or a number of sketches can be defined. Determining the setting included using a fitting or hyper-tuning process (e.g., using a sweep analysis). In some instances, a sketching process and number of projections is first set and one or more other variables are then determined based on hyper-tuning.

More specifically, when the Simhash sketching processing was used, the number of projections was set to 12. The resulting dimensionality was then defined as 120. When model-based embedding was used (e.g., 1-hot encoding or encoder embedding), the number of projects was set to 32. The resulting dimensionality was then defined as 128. The number of projections for the SAVAE encoding was set to 16.

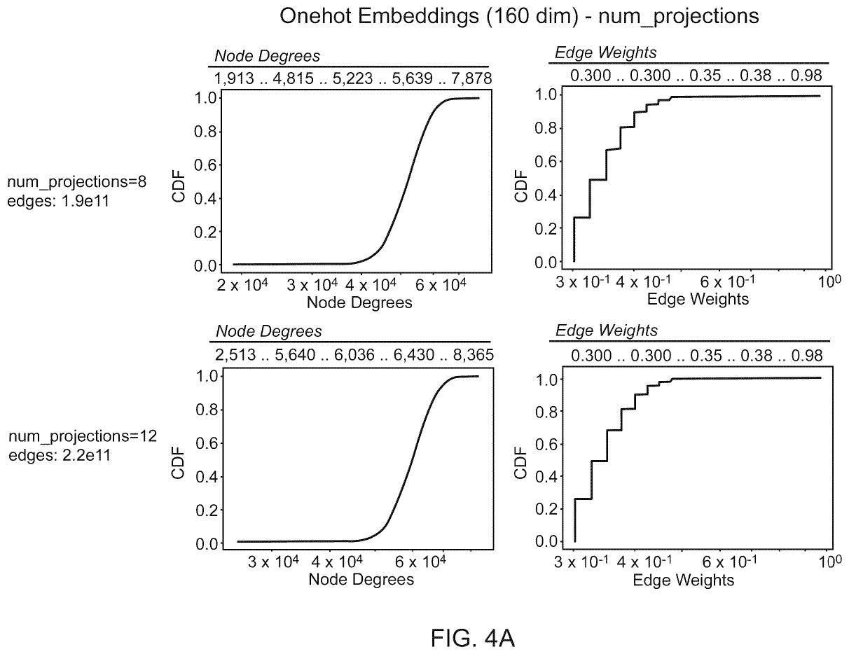

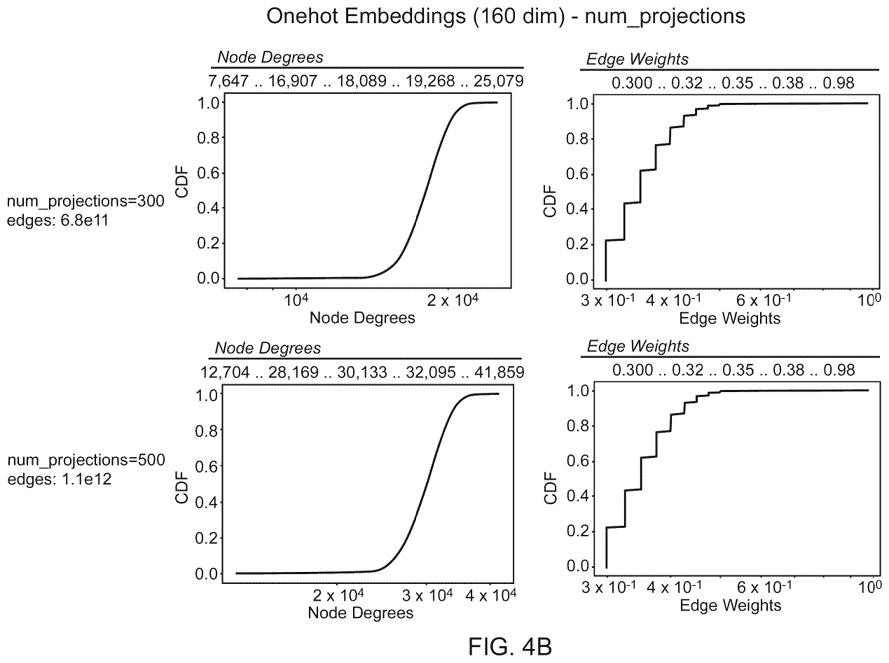

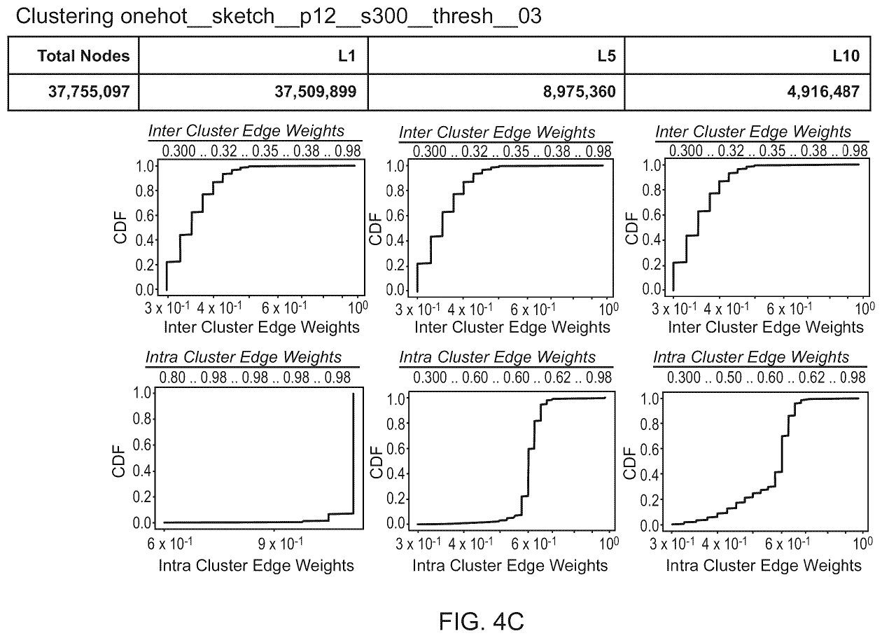

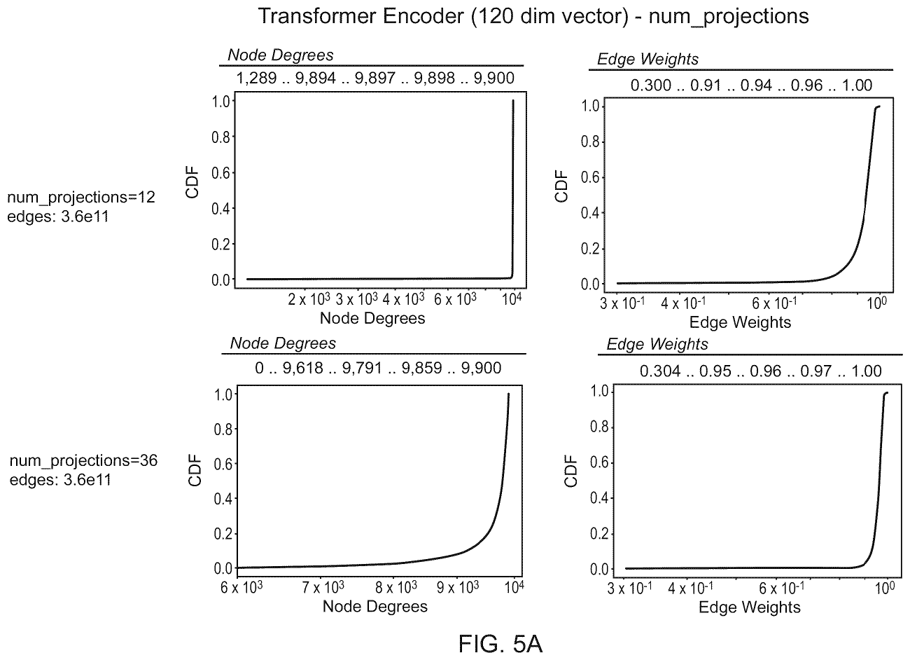

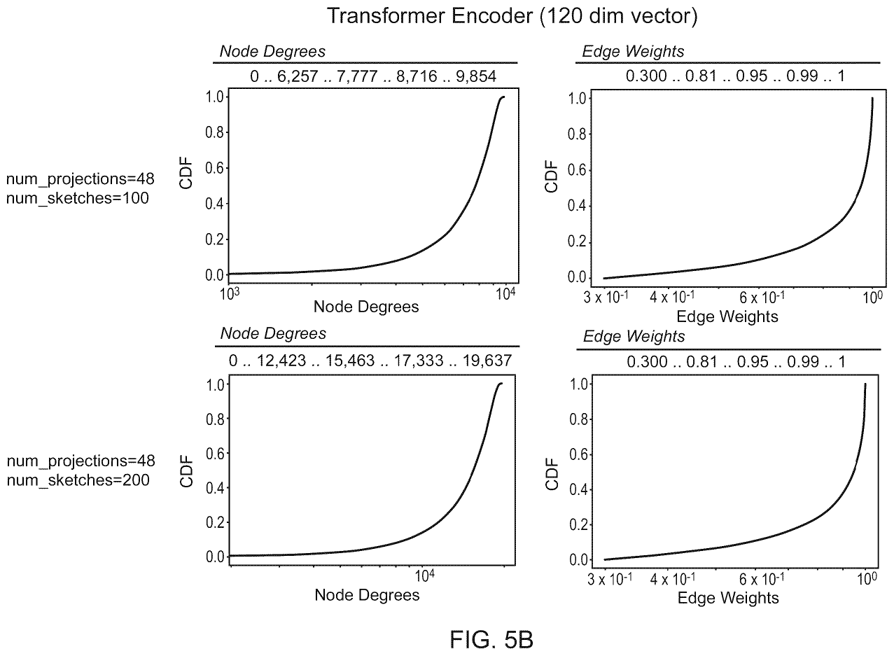

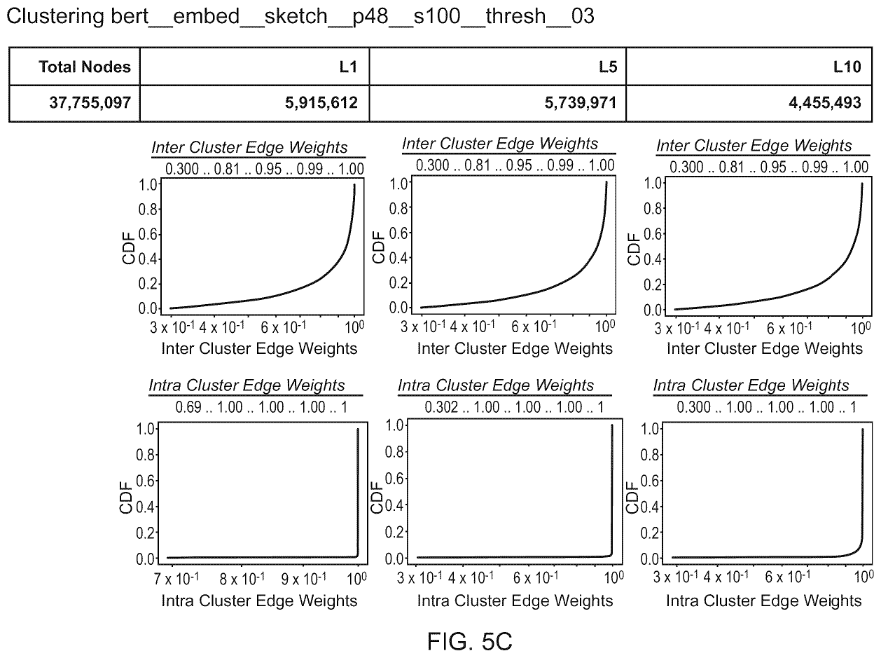

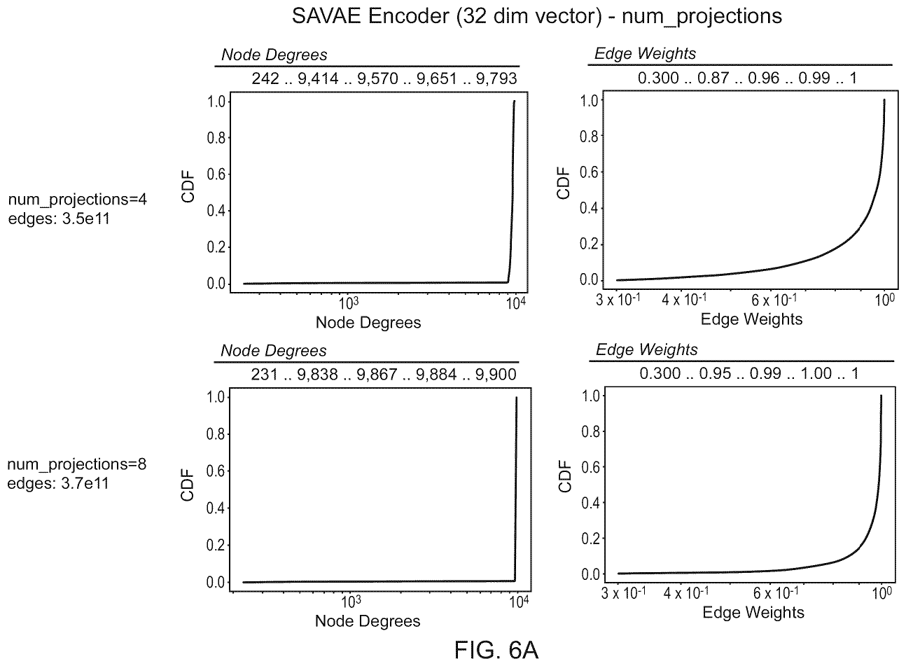

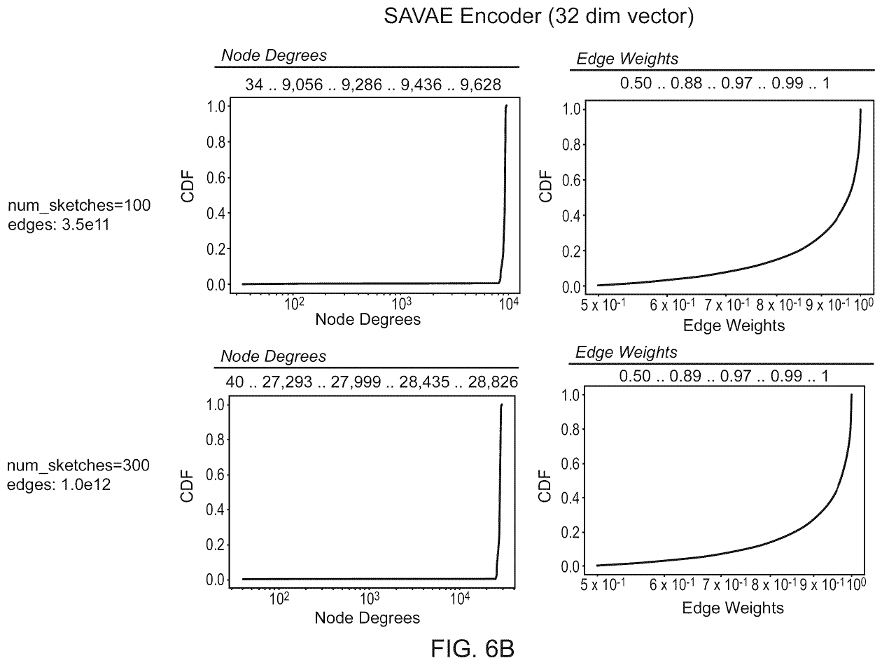

FIGS. 4A-4C, 5A-5C and 6A-6B illustrate the influence of various parameters on various embedding-related characteristics pertaining to the one-hot embeddings, Transformer Encoder embeddings, and SAVAE embeddings, respectively. More specifically, FIGS. 4A-4C pertain to one-hot embeddings; FIGS. 5A-5C pertain to Transformer Encoder embeddings, and FIGS. 6A-6B pertain to SAVAE embeddings.

FIGS. 4A, 5A and 6A relate to how the number of sketches influences the number cumulative normalized number of node degrees and edge weights, which are cumulative fractions of either the nodes with the specified number of out-edges or the edges with the given weight. The two rows correspond to a different number or projections. Notably, the number of node degrees and edge weights are positively correlated with the number of sketches. The number of projections modestly improved the shape and distribution of the node degrees and edge weights. As illustrated by comparing the left-hand plots across the two rows in these figures, there is a smaller difference in the most and least connected node as the number of projections increase. Meanwhile, the cumulative distribution functions (CDFs) are similar across the different projection quantities.

FIGS. 4B, 5B and 6B show how the cumulative normalized number of edge weights depend on node degrees (left plots) and how the cumulative normalized number of node degrees depend on edge weights (right plots). This data can facilitate defining hyperparameters to facilitate generation of stable clusters. As indicated, particular values were determined for the projection-number parameter and for the number of projections per vector used during the sketch process. A projection for each aptamer was then defined, and affinity clustering was performed. The affinity clustering can be a hierarchical clustering, iterative clustering, a clustering based on Boruvka's MST algorithm, and/or a clustering technique disclosed in Bateni et al., “Affinity Clustering: Hierarchical Clustering at Scale”, Advances in Neural Information Processing Systems 30 , 2017 (available at https://papers.nips.cc/paper/2017/hash/2e1b24a664f5e9c18f407b2f9c73e821-Abstract.html, which is hereby incorporated by reference in its entirety for all purposes). Affinity clustering may allow for the selection of a clustering level that is advantageous for a given number of sequences in a training set or exploration state; may support clustering without requiring a specification of a number of a clusters; may be scalable (e.g., to facilitate parallel processing), and/or may facilitate detecting clusters that are not necessarily dense. FIGS. 4C and 5C show how the CDFs of the average inter-cluster edge weights (top row) and the intra-cluster edge weights (bottom row) change across iterations of the affinity clustering as performed in accordance with the technique disclosed in Bateni et al. It may be advantageous to select an iteration that corresponds to a relatively small intra-cluster edge weight and a relatively large inter-cluster edge weight.

While one approach to define clusters is to generate projections and to identify clusters using a particular projection approach, another approach is to define clusters based on projections from multiple projection approaches. In this example, features generated by one-hot encoding, Kmer tokenization, BERT embedding, and SAVAE embedding were combined to generate an aggregate feature set. Lower and upper bounds were defined for each feature, and each feature was normalized.

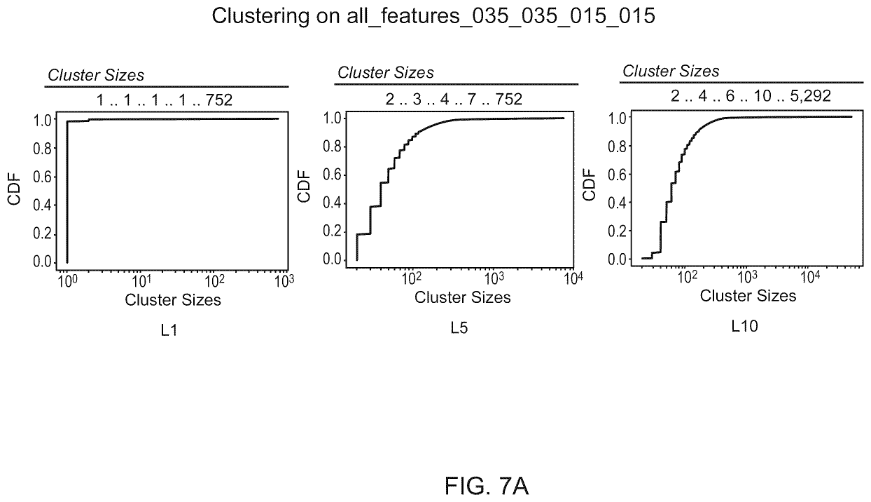

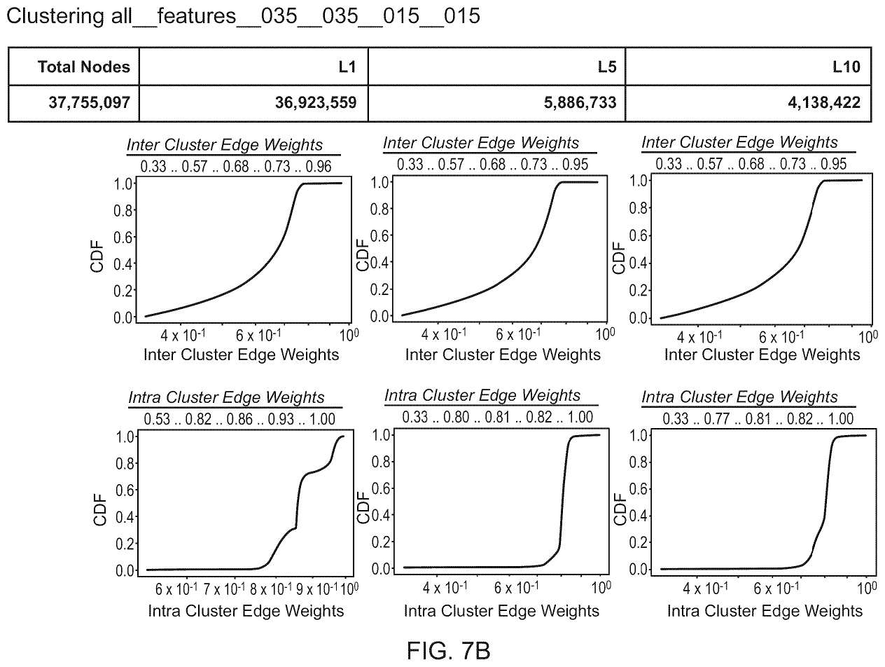

In this Example, the features from the one-hot encoding and Kmer tokenization were each assigned a 35% weight, whereas the features from the BERT embedding and SAVAE embedding were each assigned a 15% weight. Affinity clustering was performed. FIG. 7A shows how the CDF of cluster sizes changes as the iteration of the clustering proceeds. FIG. 7B shows how the CDF of the inter-cluster edge weights (top plots) and of the intra-cluster edge weights (bottom plots) changes as the iteration of the clustering proceeds. Notably, the intra-cluster edge weight plot of the L5 iteration has a particularly sharp rise as compared to that from the L1 and L10 iterations. These graphs suggest that selecting the L5 iteration may facilitate identifying clusters that have a predominate label assignment (whereas others predominately have another label assignment). Thus, aptamers in the identified clusters may be experimentally investigated.

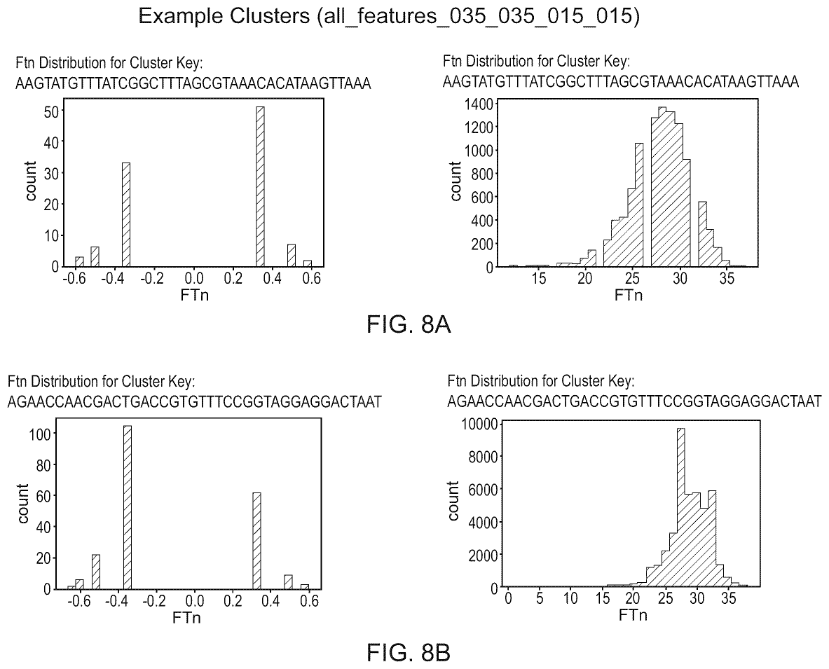

In this Example, for each of the largest 10,000 clusters, an average FTn was calculated across clusters with a minimum number of sequences (s), as was an average flow through normalized (FTn) of x randomly sampled sequences. FIGS. 8A and 8B show the distribution of FTn across aptamer-pair representations for two targets. The left plots correspond to the inter-cluster data, and the right plots correspond to the intra-cluster data. Across targets, the “standard error” of the former average FTn was 0.100 and of the latter average FTn was 0.038.

Some embodiments of the present disclosure include a system including one or more data processors. In some embodiments, the system includes a non-transitory computer readable storage medium containing instructions which, when executed on the one or more data processors, cause the one or more data processors to perform part or all of one or more methods and/or part or all of one or more processes disclosed herein. Some embodiments of the present disclosure include a computer-program product tangibly embodied in a non-transitory machine-readable storage medium, including instructions configured to cause one or more data processors to perform part or all of one or more methods and/or part or all of one or more processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification, and variation of the concepts herein disclosed may be resorted to by those skilled in the art, and that such modifications and variations are considered to be within the scope of this invention as defined by the appended claims.

The description provides preferred exemplary embodiments only, and is not intended to limit the scope, applicability or configuration of the disclosure. Rather, the description of the preferred exemplary embodiments will provide those skilled in the art with an enabling description for implementing various embodiments. It is understood that various changes may be made in the function and arrangement of elements without departing from the spirit and scope as set forth in the appended claims.

Specific details are given in the following description to provide a thorough understanding of the embodiments. However, it will be understood that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

What is claimed is:

1. A computer-implementer method comprising:
identifying a binding target of interest;
for each aptamer of a plurality of aptamers:
identifying a sequence for the aptamer;
generating, using each of a set of machine-learning models and using the sequence, a projection for the aptamer; and
generating an aggregate representation for the aptamer based on the projections;
performing a clustering-based process using the aggregate representations of the set of aptamers so as to generate a set of clusters, wherein at least two of the set of aptamers are assigned to each cluster of the set of clusters;
for each cluster of the set of clusters:
identifying, for each aptamer assigned to the cluster, an aptamer-specific binding metric corresponding to the aptamer and a specific target; and
determining a cluster-specific binding metric based on the aptamer-specific binding metrics corresponding to the aptamers assigned to the cluster and to specific target;
selecting a subset of the set of clusters based on the cluster-specific binding metrics, where the subset is smaller than the set of clusters; and
outputting an identification of aptamers corresponding to the selected subset of the at least two of the set of clusters.

2. The computer-implemented method of claim 1, further comprising, for each cluster of the at least two of the set of clusters:
identifying a binding-metric difference condition;
detecting one or more aptamers for which the bind-metric difference condition is satisfied; and
modifying, for each of the one or more aptamers, the aptamer-specific binding metric, wherein the output identifies the one or more aptamers.

3. The computer-implemented method of claim 1, further comprising:
calculating, for each cluster of the set of clusters, a skew, precision, standard deviation, or variance of the aptamer-specific binding metrics for aptamers assigned to the cluster, wherein the subset of the set of clusters are selected based on the skews, precisions, standard deviations, or variances.

4. The computer-implemented method of claim 1, wherein performing the clustering-based process includes performing an initial clustering and performing a subsequent iterative merging of various clusters.

5. The computer-implemented method of claim 1, wherein the set of machine-learning models includes a language model.

6. The computer-implemented method of claim 1, wherein the set of machine-learning models includes a variational autoencoder or a modified version thereof.

7. The computer-implemented method of claim 1, wherein the set of machine-learning models includes a deep neural network.

8. The computer-implemented method of claim 1, wherein performing the clustering-includes, for each aptamer of the set of aptamers:
projecting the aggregate representation for the aptamer along each of one or more defined axes; and
computing, for each other aptamer of one or more other aptamers in the set of aptamers, a dot product between the projection of the aggregate representation and a projection of the other aptamer.

9. The computer-implemented method of claim 1, wherein performing the clustering-includes:
performing a sketching process to produce a set of candidate pairs, wherein each of the set of candidate pairs includes aggregate representations of two aptamers, and wherein the set of candidate pairs is a subset of a total pair-wise combinations of aggregate representations of the set of aptamers; and
calculating, for each candidate pair of the set of candidate pairs, a similarity measure between the aggregate representations of the two aptamers in the candidate pair.

10. A system comprising:
one or more data processors; and
a non-transitory computer readable storage medium containing instructions which, when executed on the one or more data processors, cause the one or more data processors to perform a set of actions including:
identifying a binding target of interest;
for each aptamer of a set of aptamers:
identifying a sequence for the aptamer;
generating, using each of a set of machine-learning models and using the sequence, a projection for the aptamer; and
generating an aggregate representation for the aptamer based on the projections;
performing a clustering-based process using the aggregate representations of the set of aptamers so as to generate a set of clusters, wherein at least two of the set of aptamers are assigned to each cluster of the set of clusters; and
for each cluster of the set of clusters:
identifying, for each aptamer assigned to the cluster, an aptamer-specific binding metric corresponding to the aptamer and a specific target; and
determining a cluster-specific binding metric based on the aptamer-specific binding metrics corresponding to the aptamers assigned to the cluster and to specific target;
selecting a subset of the set of clusters based on the cluster-specific binding metrics, where the subset is smaller than the set of clusters; and
outputting an identification of aptamers corresponding to the selected subset of the at least two of the set of clusters.

11. The system of claim 10, wherein the set of actions further includes, for each cluster of the at least two of the set of clusters:
identifying a binding-metric difference condition;
detecting one or more aptamers for which the bind-metric difference condition is satisfied; and
modifying, for each of the one or more aptamers, the aptamer-specific binding metric, wherein the output identifies the one or more aptamers.

12. The system of claim 10, wherein the set of actions further includes:
calculating, for each cluster of the set of clusters, a skew, precision, standard deviation, or variance of the aptamer-specific binding metrics for aptamers assigned to the cluster, wherein the subset of the set of clusters are selected based on the skews, precisions, standard deviations, or variances.

13. The system of claim 10, wherein performing the clustering-based process includes performing an initial clustering and performing a subsequent iterative merging of various clusters.

14. The system of claim 10, wherein the set of machine-learning models includes a language model.

15. The system of claim 10, wherein the set of machine-learning models includes a variational autoencoder or a modified version thereof.

16. The system of claim 10, wherein the set of machine-learning models includes a deep neural network.

17. The system of claim 10, wherein performing the clustering-includes, for each aptamer of the set of aptamers:
projecting the aggregate representation for the aptamer along each of one or more defined axes; and
computing, for each other aptamer of one or more other aptamers in the set of aptamers, a dot product between the projection of the aggregate representation and a projection of the other aptamer.

18. The system of claim 10, wherein performing the clustering-includes:
performing a sketching process to produce a set of candidate pairs, wherein each of the set of candidate pairs includes aggregate representations of two aptamers, and wherein the set of candidate pairs is a subset of a total pair-wise combinations of aggregate representations of the set of aptamers; and
calculating, for each candidate pair of the set of candidate pairs, a similarity measure between the aggregate representations of the two aptamers in the candidate pair.

19. A computer-program product tangibly embodied in a non-transitory machine-readable storage medium, including instructions configured to cause one or more data processors to perform a set of actions including:
for each aptamer of a set of aptamers:
identifying a sequence for the aptamer;
generating, using each of a set of machine-learning models and using the sequence, a projection for the aptamer; and
generating an aggregate representation for the aptamer based on the projections;
performing a clustering-based process using the aggregate representations of the set of aptamers so as to generate a set of clusters, wherein at least two of the set of aptamers are assigned to each cluster of the set of clusters; and
for each cluster of the set of clusters:
identifying, for each aptamer assigned to the cluster, an aptamer-specific binding metric corresponding to the aptamer and a specific target; and
determining a cluster-specific binding metric based on the aptamer-specific binding metrics corresponding to the aptamers assigned to the cluster and to specific target;
selecting a subset of the set of clusters based on the cluster-specific binding metrics; and
outputting an identification of aptamers corresponding to the selected subset of the at least two of the set of clusters.

20. The computer-program product of claim 19, wherein the set of actions further includes, for each cluster of the at least two of the set of clusters:
identifying a binding-metric difference condition;
detecting one or more aptamers for which the bind-metric difference condition is satisfied; and
modifying, for each of the one or more aptamers, the aptamer-specific binding metric, wherein the output identifies the one or more aptamers.


SEQUENCE LISTING (10 sequences)

SEQ ID NO: 1 - DNA, 30 bp, synthetic construct
  source 1..30: mol_type = other DNA
gaggatacgaggagaggaggagaagctcgg

SEQ ID NO: 2 - DNA, 30 bp, synthetic construct
  source 1..30: mol_type = other DNA
gaggatacgaggagaggaggagaacctcgg

SEQ ID NO: 3 - DNA, 30 bp, synthetic construct
  source 1..30: mol_type = other DNA
gaggacacgaggggaggaagataacgtcgg

SEQ ID NO: 4 - DNA, 30 bp, synthetic construct
  source 1..30: mol_type = other DNA
gaggacacgagggcaggaaactaacgtcgg

SEQ ID NO: 5 - DNA, 30 bp, synthetic construct
  source 1..30: mol_type = other DNA
gaggacacgagggcaggacagtaacgtcgg

SEQ ID NO: 6 - DNA, 30 bp, synthetic construct
  source 1..30: mol_type = other DNA
ggggacacgaggggagggcagtaacctccg

SEQ ID NO: 7 - DNA, 30 bp, synthetic construct
  source 1..30: mol_type = other DNA
gaggacacgaggcgcgggacgtaaactccg

SEQ ID NO: 8 - DNA, 30 bp, synthetic construct
  source 1..30: mol_type = other DNA
ggagacacgaggcccggcaccgaaactccg

SEQ ID NO: 9 - DNA, 30 bp, synthetic construct
  source 1..30: mol_type = other DNA
ggagacgcgagacagggcagtgaaactccg

SEQ ID NO: 10 - DNA, 30 bp, synthetic construct
  source 1..30: mol_type = other DNA
gtagacgcgagacgccgcgttaatatttcg